(19) United States
(12) Patent Application Publication
(10) Pub. No.: US 2012/0019663 A1
(43) Pub. Date: Jan. 26, 2012

(54) AUTOMATIC CONTROL MODULE FOR ELECTRONIC APPARATUS

(75) Inventor: Jeffrey Raynor, Edinburgh (GB)

(73) Assignee: STMicroelectronics (Research & Development) Limited, Marlow (GB)

(21) Appl. No.: 13/189,733

(22) Filed: Jul. 25, 2011

(30) Foreign Application Priority Data
Jul. 26, 2010 (GB) 1012467.5

(51) Int. Cl. G06K 9/62; H04N 5/33

(52) U.S. Cl. 348/164; 382/224; 348/E05.09

(57) ABSTRACT

A module is configured to control an electronic device equipped with an optical receiver for wireless remote control. The module includes a face detection circuit that detects the presence of a face within an area proximate to the electronic device. An optical transmission circuit operates to transmit an optical control signal to the electronic device in response a detected change in face detection status made by the face detection circuit. To assist operation of the face detection circuit, the optical transmission circuit is further configured to illuminate an area proximate to the electronic device.

### PRIORITY CLAIM

This application claims priority from United Kingdom Patent Application No. 1012467.5 filed Jul. 26, 2010, the disclosure of which is hereby incorporated by reference.

### TECHNICAL FIELD

The invention relates to a module for controlling an electronic apparatus, for example a home entertainment apparatus, in dependence on the presence, or not, of a user, and in particular such a module that will automatically switch off a device when no user is present.

### BACKGROUND

Often users will not turn off their television sets, DVD players etc. when they are not in the room, thus resulting in a waste of energy. Also, it can be inconvenient to locate a remote control to pause a DVD, satellite/digital receiver or similar apparatus, for example when a doorbell or telephone rings, necessitating the watcher to leave the room.

Some devices have a “sleep” mode which turns off the device after a pre-determined period of time. These require the user to set them each time the system is activated and are inflexible. For example, if the user leaves the room, the system has not detected this and will keep the system powered and running.

There is a need in the art to address these drawbacks.

### SUMMARY

In a first aspect there is provided a module for controlling one or more electronic devices equipped with an optical receiver for wireless remote control, said module comprising: face detection means for detecting the presence of a face in proximity to said one or more electronic devices; and optical transmission means for transmitting an optical control signal to at least one of said one or more electronic devices in response to the detection status of said face detection means; wherein said optical transmission means is further operable to illuminate said proximity to said one or more electronic devices so as to aid functioning of said face detection means.

Said optical transmitter and receiver means may be operable to use infra-red radiation, said transmitter means comprising an infra-red light emitting diode.

Said module may be designed to be physically separate from said one or more electronic devices, and may be able to operate said one or more electronic devices without any modification. In the latter case, while electronic device manufacturers may choose to include a specific code to improve inter-operability of the module and electronic devices in some way, it should be recognized that said module would still be able to control said device without such specific code, and instead using only control signals that the electronic device's dedicated remote control uses.

Said module may be designed to be comprised within a host device, said host device being one of said one or more electronic devices. In such a case, said module may source its power from said host device. Said module may comprise a back-up battery so as to be operable when said host device is switched off. Said back-up battery may be charged by said host device when said host device is on. Said module may have a physical connection to said host device for sending a control signal in response to the detection status of said face detection means. Said device may still be operable to transmit said infra-red control signal for control of a further electronic device other than said host device.

Said module may be operable to send a plurality of different control signals. Said plurality of control signals may comprise different control signals for the operation of different devices and/or for the operation of different functions of each device. Said module may be operable to automatically send a control signal to each of a plurality of different devices in response to a single change in said detection status of said face detection means. At least one of said plurality of devices may be controlled to perform a different function from the other(s), in response to said single change in said detection status.

Said module may comprise means for receiving and learning control signals from other control devices, such that said transmission means is able to mimic said learned control signal. Alternatively, or in addition, said module may have a plurality of control signals pre-programmed, so that they can be pre-selected for use by said module, by a user, depending on said electronic device(s).

Said transmission means may be operable to illuminate said proximity all the time that it is operational. Alternatively its illumination output may be pulse wave modulated. Said module may further comprise means for measuring ambient light levels and be operable to use said transmission means for illumination only when said ambient light falls below a predetermined level.

### BRIEF DESCRIPTION OF THE DRAWINGS

Embodiments of the invention will now be described, by way of example only, by reference to the accompanying drawings, in which:

FIG. 1 is a block diagram of a remote module according to an embodiment of the invention;

FIG. 2 shows a complete system incorporating the module of FIG. 1 as a stand-alone device; and

FIG. 3 shows a further embodiment of the invention whereby the module of FIG. 1 is incorporated inside a television set.

### DETAILED DESCRIPTION OF THE DRAWINGS

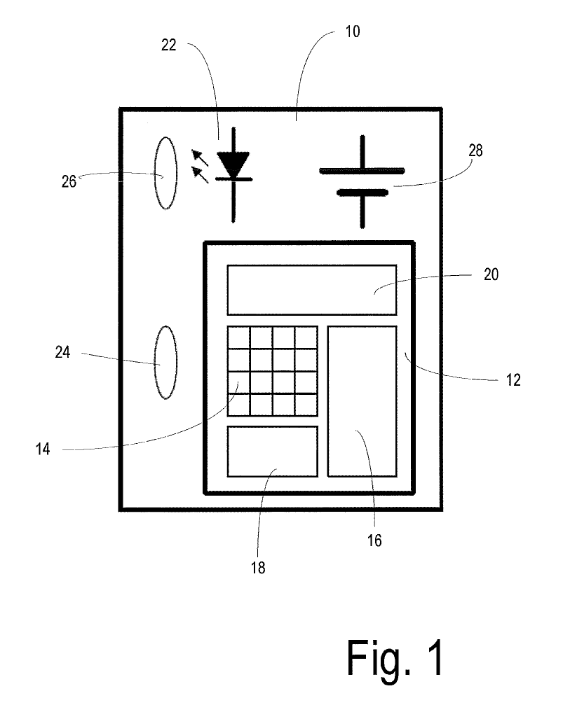

FIG. 1 is a block diagram of a remote module 10 according to an embodiment of the invention. It has sensor chip 12 which comprises of an array of pixels 14 (100×100 is typically the minimum size of the array), associated readout circuitry 18, and image processing logic 16 incorporating functionality for face detection, automatic exposure control, etc. The sensor chip 12 also has an LED control 20. Optionally, the sensor chip may also have an IR receiver and demodulator circuitry so that it can receive, decode and store the control sequence from an IR remote controller. In this embodiment, the module 10 is a stand-alone/independent device which does not require modification to any home entertainment equipment with which it is used.

The module also contains an IR LED 22 (typically 850 nm is used as its radiation is not visible to the human eye but is readily detected by the CMOS image sensor), an optical system 24 suitable for forming images of the scene onto the image array 14 and a separate optics system 26 to illuminate the room using light from the LED 22. Consequently, IR LED 22 (under control of LED control 20) can be used to illuminate a subject watching television and also to generate infra-red (IR) remote control pulses.

Optionally, the module 10 contains a dye which blocks visible light from the sensor 12. Typically, the module also contains a power source, e.g. battery 28 although the module may be built into a device such as a television or DVD player (as described below), in which case power could be provided from the mains.

With the improvement in silicon device technology, the cost of image sensing and processing is reduced such that it is now practical to incorporate a sensor and image processing system onto a single chip. For example, an optical mouse is usually fabricated from a single piece of silicon containing not only the sensor but also circuitry implementing a sophisticated algorithm to detect motion in real-time. It is also possible to incorporate a sensor and image processing system which is able to detect human faces in a scene. These systems are now quite popular on digital still cameras (DSC). Such systems are used to detect which region of the image has a face, this region being used by the auto-expose or auto-focus algorithms to ensure the image is correctly exposed and in focus.

Face detection has been selected as the preferred method of sensing the presence of a user due to this reduction in cost and practicality and due to its accuracy. Other detection mechanisms were considered but have certain limitations such as lack of ability to detect at distances over half a meter, e.g. capacitive “touch” systems, practicality and cost e.g. active IR detection, or the ability to continue to sense a person who moves infrequently, e.g. passive IR detection.

Although modern CMOS image sensors produce an acceptable image in low light levels (e.g. less than 100 Lux), to ensure the face detection and or the focusing system have images of sufficiently high quality for their algorithms to operate correctly, some DSC use LEDs to illuminate the scene. Typically, these LEDs have wavelengths in the visible region. The reason for this is two-fold. Firstly, it helps the user to aim the camera at the appropriate subject and secondly, sensors typically have IR blocking filters in their optical path to ensure fidelity of color images.

Such issues are not relevant to the present device, which is therefore able to use the IR LED 22 in the face detection module both as a scene illumination and as a source for the television/DVD remote control. When used for scene illumination it may be programmed to be on all of the time, or in some energy saving mode, such as being pulse wave modulated at the frequency of the frame rate, typically Hz.

The module may have a switch (or switch input circuitry such as general purpose input/output GPIO) so that it can be commanded to receive and learn the control signals from a remote control. This can be done in the same way as third party remote controls, which are able to operate various brands of equipment. These can be programmed by the user by pointing their existing remote control at the universal remote control which will receive and store the appropriate control sequence. Alternatively, or in addition, the module may have control signals for many devices pre-programmed within, the appropriate signals being chosen by the user selecting the make/model of the television set/DVD player from a list.

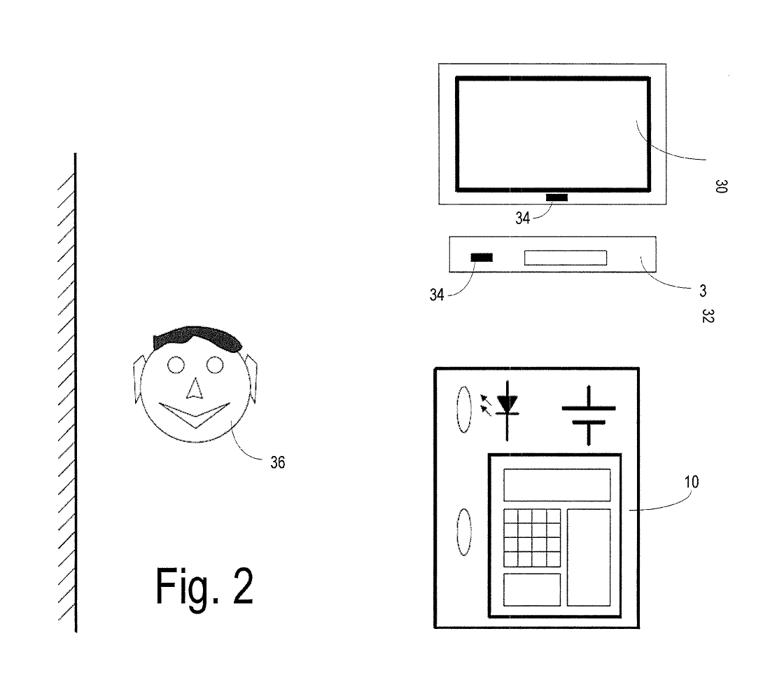

FIG. 2 shows a complete system incorporating the module 10 of FIG. 1 (all elements of module 10 have the same label as in FIG. 1). Typical home appliances, such as a television set 30 and a DVD player, set-top box, receiver, amplifier etc 32. are shown with their associated IR remote control receiver 34. Light from the IR LED 22 and/or ambient light is used to illuminate the scene and observe the presence or absence of a user 36. The face detection sensor 12 may incorporate dedicated ambient light sensor (ALS) circuitry or use data from the automatic exposure control system to detect ambient light levels. Under high levels of ambient light, the IR LED 22 may not be illuminated, thereby saving power; the IR LED 22 being used only at lower levels of ambient light, so as to ensure adequate scene illumination for the face detection algorithm to operate.

When the user 36 enters or leaves the field of view, the face detection sensor 12 determines this fact and signals a suitable command to the home entertainment electronics 30, 32 using a pulse train or IR control signal via IR light 22. These photons are reflected from the wall or other furniture and impinge on the IR remote receivers 34 of the home entertainment equipment 30, 32. There are various IR remote control protocols. The most common are RC-5 and RC-6 from Philips but other include NEC TC101, Panasonic RECS-80, and the SIRCS from Sony. Suitable commands should the system detect that a user has left include (separately or in combination) turning off the display, putting a DVD player into pause or a PVR into “pause live video mode”. Similarly, if the system detects that a user has returned to the field of view, the display can be turned back on, the DVD put back into play mode and the PVR “un-paused”. Optionally, the module has interface circuitry which allows the host direct control over the LED, such that it can be used as a conventional remote control.

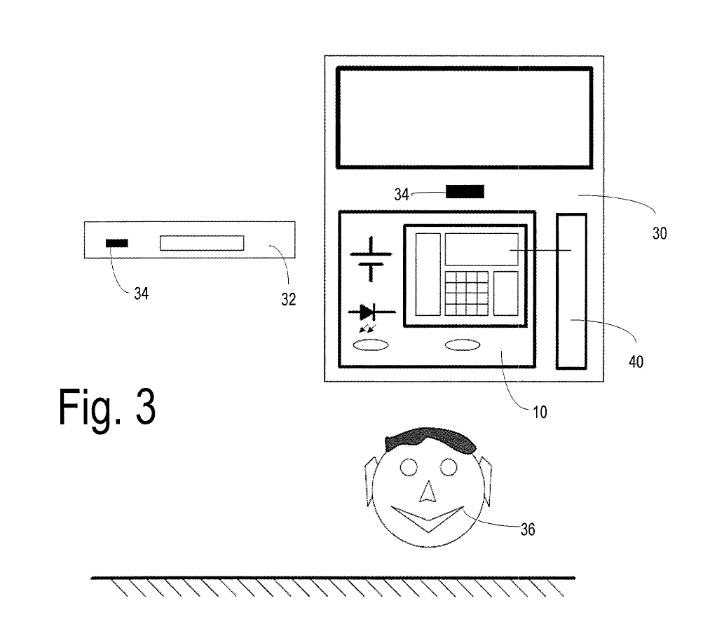

FIG. 3 shows a further embodiment of the invention whereby the module 10 is incorporated inside the television set 30 (in reality the module is likely to be considerably smaller than the television screen). The television 30 has an aperture to enable the transmission of light from the LED 22 and also for light from the scene to reach the detector. If an aperture in the television is aesthetically displeasing, the system could be made to operate in only IR light and a window of plastic used to block visible light but pass IR light. Typical material for such a filter is Lexan (c) GE, 121R-21051. Having the face detection module incorporated inside the television set (or other appliance) has several advantages.

First of all, the sensor plane and the television screen plane can be made co-planar and hence the sensor will automatically be aligned with the field of view of the screen, making it easier to detect a face in the region in front of the screen, where a viewer is to be expected.

Secondly, as the television set (or other) is typically mains powered, the face detection module can use higher power levels. For example increased power to the IR LED 22 will permit its use in larger, dark rooms where the subject is further away from the light source and more power needs to be emitted from the LED 22 to reach an acceptable illumination level. Consequently, the module 10 may not need to be battery powered, and may source its power from the television 30. If the module 10 does contain a battery, then even if the television 30 is placed into shutdown mode, the face detection sensor 12 of the module 10 could be used to wake it up. The television 30 could also charge the battery 28.

Another advantage is that there is now an electrical communication path between the face detection module 10 and the television control circuitry 40. Therefore the face-detection module 10 can signal directly to the television 30 that the user is present/not-present and switch the television 30 into standby/power-off as appropriate and according to the user's configuration (e.g. by setting various options on the television using the remote control). Also, the face detection module needs to command one fewer device via IR. For example, in FIG. 3, the television 30 may be controlled by the module 10 electronically while the DVD player 32 is controlled optically.

Also, the module 10 may have interface circuitry that allows the host to upload a command sequence into the module. The television could upload the control sequence to the face detection module 10 via this connection. For example, the television could use its existing IR remote control receiver circuitry to learn the “pause” button and/or “play” button for the DVD and communicate these pulse-trains to the face detection module 10. Hence the face detection module 10 would not need a separate IR receiver circuitry and could issue the “DVD pause” pulse train (while switching off the television, or otherwise) when there is no-one in the room and “DVD play” pulse train (while switching on the television, or otherwise) when someone re-enters the room.

It will be appreciated that the specific embodiments illustrated above are described by way of example only and other embodiments and variations can be envisaged without departing from the sprit or scope of the invention. In particular, while the device has been described in terms of television and video apparatus, it is equally usable with predominately audio apparatus such as Hi-Fi or radio equipment.

What is claimed is:

1. A module for controlling one or more electronic devices equipped with an optical receiver for wireless remote control, said module comprising:
a face detection circuit configured to detect the presence of a face in proximity to said one or more electronic devices; and
an optical transmission circuit configured to transmit an optical control signal to at least one of said one or more electronic devices in response to the detection status of said face detection circuit;
wherein said optical transmission circuit is further configured to illuminate an area in proximity to said one or more electronic devices so as to aid in the functioning of said face detection circuit.

2. The module of claim 1 wherein said optical transmission circuit is operable to use infra-red radiation and include a transmitter comprising an infra-red light emitting diode.

3. The module of claim 1 wherein said module is physically separate from said one or more electronic devices.

4. The module of claim 3 wherein said module is configured to control operation said one or more electronic devices via infra-red radiation communication.

5. The module of claim 1 wherein said module is physically provided within a host device, said host device comprising one of said one or more electronic devices.

6. The module of claim 5 wherein said module receives operating power from said host device.

7. The module of claim 5 wherein said module further comprises a back-up battery, and wherein said back-up battery is charged by said host device.

8. The module of claim 5 further comprising a physical connection between the module and said host device, the module further operable to send a control signal over the physical connection in response to the detection status of said face detection circuit.

9. The module of claim 1 wherein said module is operable to send a plurality of different control signals, said plurality of control signals comprising different control signals for the operation of each said of said one or more electronic devices in response to a single change in said detection status of said face detection circuit.

10. The module of claim 1 wherein said module is operable to automatically send a control signal to each said of said one or more electronic devices in response to a single change in said detection status of said face detection circuit.

11. The module of claim 1 wherein said module is operable to send a plurality of different control signals, said plurality of control signals comprising different control signals for the operation of different functions of each of said one or more electronic devices in response to a single change in said detection status of said face detection circuit.

12. The module of claim 11 wherein said plurality of control signals control a plurality of electronic devices of said one or more electronic devices to perform different functions in response to a single change in said detection status.

13. The module of claim 1 further comprising means for receiving and learning control signals from other control devices associated with said one or more electronic devices, such that said optical transmission circuit is able to mimic said learned control signal.

14. The module of claim 1 wherein said module is pre-programmed with a plurality of control signals for other control devices associated with said one or more electronic devices, said control signals being selectable for use by said module, by a user, depending on said one or more electronic devices.

15. The module of claim 1 wherein said illumination of an area in proximity to said one or more electronic devices comprises a pulse wave modulated illumination.

16. The module of claim 1 wherein said optical transmission circuit is operable to illuminate said area in proximity to said one or more electronic devices all the times that the module is operational.

17. The module of claim 1 further comprising means for measuring ambient light levels in said area in proximity to said one or more electronic devices and controlling said optical transmission circuit to provide illumination only when said ambient light falls below a predetermined level.

18. Apparatus, comprising:
a face detection circuit configured to detect a change in presence of a face in an area proximate to a remotely controllable electronic device; and
a circuit configured to transmit a remote control signal to said remotely controllable electronic device in response to said face detection circuit detecting said change in presence of the face in the area proximate to the remotely controllable electronic device.

19. The apparatus of claim 18 wherein said remote control signal is an infrared control signal.

20. The apparatus of claim 18 wherein said remote control signal is an electrical control signal.

21. The apparatus of claim 18 further comprising illumination circuitry configured to illuminate the area proximate to the remotely controllable electronic device so as to assist the face detection circuit is detecting presence of the face in said area.

22. The apparatus of claim 21 wherein said illumination circuitry is further operable as said circuit configured to transmit the remote control signal, wherein said remote control signal is an optical control signal.

23. The apparatus of claim 22 wherein an illumination of said area by said illumination circuitry comprises a pulse wave modulated illumination.

24. The apparatus of claim 22 further comprising means for measuring ambient light level in said area proximate to a remotely controllable electronic device and controlling said illumination circuitry to provide illumination when the measured ambient light level falls below a predetermined level.

25. A module for controlling an electronic device equipped with an optical receiver for wireless remote control, said module comprising:
a face detection circuit operable to detect a change in presence of a face in an area proximate to said electronic device; and
an optical transmission circuit operable to transmit an optical control signal to said electronic device in response to a detected change in face presence made by said face detection circuit.

26. The module of claim 25 wherein said optical transmission circuit is further operable to illuminate said area proximate to said electronic device so as to aid in functioning of said face detection circuit.

27. The module of claim 26 further comprising means for measuring ambient light levels in said area proximate to said electronic device and controlling said optical transmission circuit to provide illumination when the measured ambient light level falls below a predetermined level.
